(19) United States
(12) Patent Application Publication
(10) Pub. No.: US 2022/0171024 A1
(43) Pub. Date: Jun. 2, 2022

(54) METHOD, APPARATUS, AND NON-TRANSITORY COMPUTER READABLE MEDIUM FOR IDENTIFYING HUMAN POSTURES USING MILLIMETER-WAVE RADAR

(71) Applicant: Chiun Mai Communication Systems, Inc., New Taipei (TW)

(72) Inventors: CHIA-JUNG HU, New Taipei (TW); CHUNG-WEI CHENG, New Taipei (TW)

(21) Appl. No.: 17/539,114

(22) Filed: Nov. 30, 2021

(30) Foreign Application Priority Data
Nov. 30, 2020 (TW) 109142131

(51) Int. Cl. G01S 7/41; G01S 13/42; G01S 13/89

(52) U.S. Cl. CPC G01S 7/412; G01S 7/354; G01S 13/89; G01S 13/42

(57) ABSTRACT

A method for identifying human postures includes obtaining millimeter-wave radar backscattered signal including point cloud information in a millimeter-wave radar detection range; determining whether a human exists in the detection range according to the millimeter-wave radar backscattered signal; determining a human centroid according to the point cloud information; removing noise of the point cloud information according to the human centroid; and identifying a human posture according to the point cloud information after noise removal. An apparatus and a non-transitory computer readable medium for identifying human postures are also disclosed.

### CROSS-REFERENCE TO RELATED APPLICATIONS

This application claims priority to Taiwan Patent Application No. 109142131 filed on Nov. 30, 2020, the contents of which are incorporated by reference herein.

### FIELD

The subject matter herein generally relates to wireless communication technology, and particularly to a method, an apparatus, and a non-transitory computer readable medium for identifying human postures using millimeter-wave radar.

### BACKGROUND

For patients and elderly people who are less flexible and have difficulty in moving, accidents may happen. Surveillance cameras can be used to monitor the patients and elderly people for indicating an accident or a possibility of accident, but the footage of surveillance cameras may itself cause privacy leaks or become public in an unauthorized way.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 illustrates a schematic view of an embodiment of a system for identifying human postures.

FIG. 2 is a flowchart of an embodiment of a method for identifying human postures.

FIG. 3 is a flowchart of an embodiment of a method of determining a human exists in the detection range according to the millimeter-wave radar backscattered signal of the method of FIG. 2.

FIG. 4 is a flowchart of an embodiment of a method of determining a human exists in the detection range according to the RCS of the method of FIG. 2.

FIG. 5 is a flowchart of an embodiment of a method of identifying human postures according to removing noise of the point cloud information according to a human centroid by ghost image cancellation of the method of FIG. 2.

FIG. 6 is a flowchart of an embodiment of a method of identifying human postures according to the point cloud information after noise removal of the method of FIG. 2.

FIG. 7 illustrates a schematic view of an embodiment of an apparatus for identifying human postures.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as Java, C, or assembly. One or more software instructions in the modules can be embedded in firmware, such as in an EPROM. The modules described herein can be implemented as either software and/or hardware modules and can be stored in any type of non-transitory computer-readable medium or another storage device. Some non-limiting examples of non-transitory computer-readable media include CDs, DVDs, BLU-RAY, flash memory, and hard disk drives. The term “comprising” means “including, but not necessarily limited to”; it in detail indicates open-ended inclusion or membership in a so-described combination, group, series, and the like.

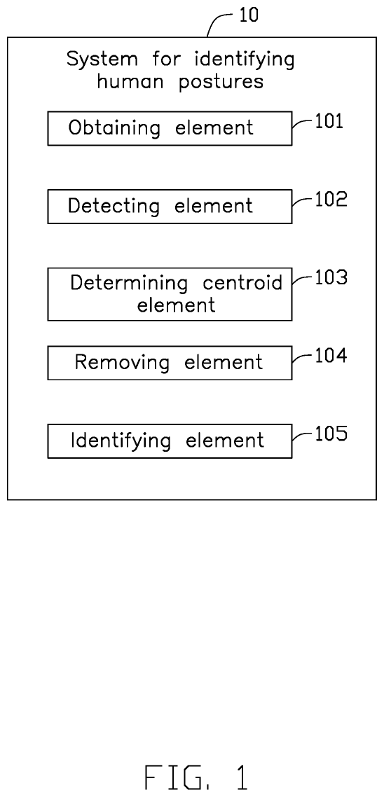

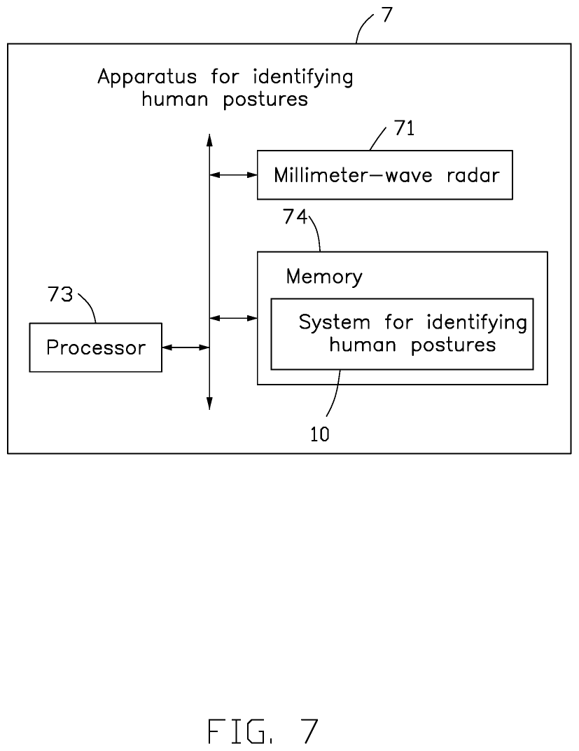

FIG. 1 illustrates a system 10 for identifying human postures applied in an apparatus 7 (shown in FIG. 7) for identifying human postures. The system 10 includes an obtaining element 101, a detecting element 102, a determining centroid element 103, a removing element 104, and an identifying element 105. The obtaining element 101 is configured to obtain millimeter-wave radar backscattered signal in a millimeter-wave radar detection range. The millimeter-wave radar backscattered signal includes point cloud information. The detecting element 102 is configured to determine whether a human exists in the detection range according to the millimeter-wave radar backscattered signal. The determining centroid element 103 is configured to determine a human centroid according to the point cloud information. The removing element 104 is configured to remove noises of the point cloud information according to the human centroid. The identifying element 105 is configured to identify a human posture according the point cloud information after noise removal.

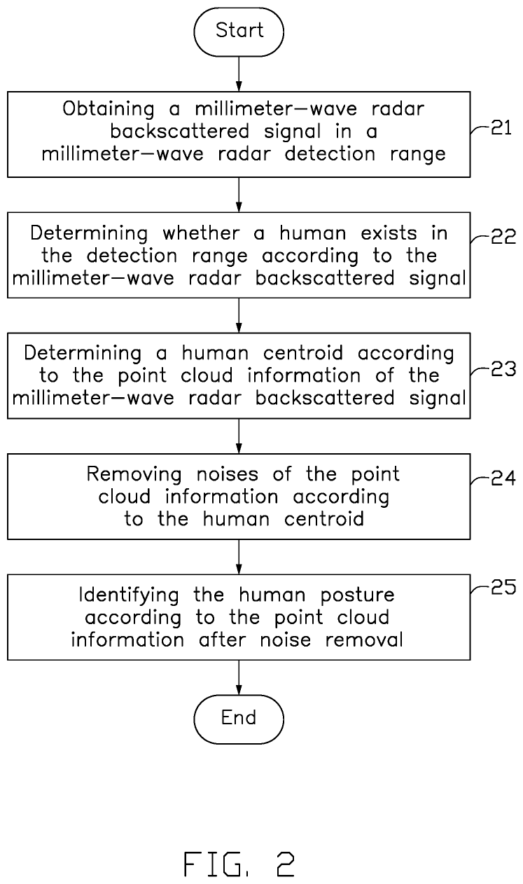

FIG. 2 illustrates a flowchart of at least one embodiment of a method for identifying human postures.

In at least one embodiment, the method for identifying human postures may be applied in an apparatus, such as the apparatus 7 shown in FIG. 7. The functions may be integrated in the apparatus for the method for identifying human postures. In another embodiment, the method for identifying human postures can be run in a form of software development kit in the apparatus.

The method is provided by way of example, as there are a variety of ways to carry out the method. Each block shown in FIG. 2 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 21.

At block 21, obtaining a millimeter-wave radar backscattered signal in a millimeter-wave radar detection range. The millimeter-wave radar backscattered signal includes point cloud information.

In at least one embodiment, the millimeter-wave radar is a radar operating at a millimeter-wave frequency band. The millimeter-wave radar is configured to transmit linear frequency modulation continuous wave signals in the detection range and receive the millimeter-wave radar backscattered signal in the detection range. The millimeter-wave radar backscattered signal includes distances of objects, speeds of objects, and angular orientation of objects, which can be used to determine human position information. The millimeter-wave radar backscattered signal includes sparse and uneven point cloud information. The point cloud information includes three-dimensional coordinate values of points in a three-dimensional coordinate system. The three-dimensional coordinate system includes an X axis, a Y axis, and a Z axis.

Before obtaining millimeter-wave radar backscattered signal in a millimeter-wave radar detection range, the method further includes sampling the millimeter-wave radar backscattered signal in the millimeter-wave radar detection range through an analog-to-digital converter. Before obtaining millimeter-wave radar backscattered signal in a millimeter-wave radar detection range, the method further includes filtering the millimeter-wave radar backscattered signal in the millimeter-wave radar detection range.

At block 22, determining whether a human exists in the detection range according to the millimeter-wave radar backscattered signal.

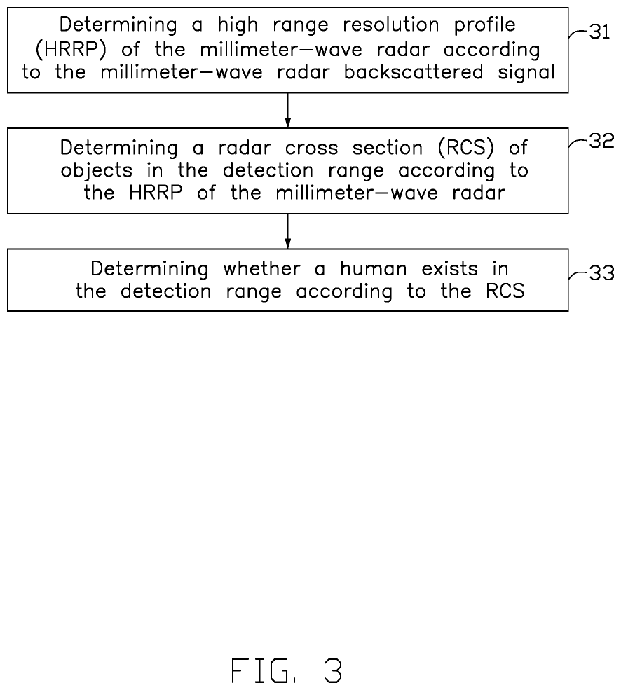

As shown in FIG. 3, the determining whether a human exists in the detection range according to the millimeter-wave radar backscattered signal further includes:

At block 31, determining a high range resolution profile (HRRP) of the millimeter-wave radar according to the millimeter-wave radar backscattered signal.

In at least one embodiment, the determining an HRRP of the millimeter-wave radar according to the millimeter-wave radar backscattered signal includes: generating the HRRP of the millimeter-wave radar through conversion of distances for the millimeter-wave radar backscattered signal.

Before determining an HRRP of the millimeter-wave radar according to the millimeter-wave radar backscattered signal, the method further includes: obtaining the linear frequency modulation continuous wave signals being transmitted in the detection range.

The determining an HRRP of the millimeter-wave radar according to the millimeter-wave radar backscattered signal includes: mixing the linear frequency modulation continuous wave signals and the millimeter-wave radar backscattered signal, and determining the HRRP of the millimeter-wave radar according to the mixed signal.

At block 32, determining a radar cross section (RCS) of objects in the detection range according to the HRRP of the millimeter-wave radar.

In at least one embodiment, after determining an RCS of the objects in the detection range according to the HRRP of the millimeter-wave radar, calculating standard deviations of RCS values of the objects in the detection range, and obtaining an adjusted value by operating a smoothing calculation to the RCS value after the standard deviation calculation. If the RCS value after the standard deviation calculation and the smoothing calculation is greater than a predetermined value, the determination is made that a human exists in the detection range.

Before calculating standard deviations of RCS values of the objects in the detection range, the method further includes: static filtering the HRRP of the millimeter-wave radar.

The smoothing calculation further includes: applying a smoothing calculation to the value of the RCS after the standard deviation calculation by a low pass filter. The low pass filter can be an alpha filter.

At block 33, determining whether a human exists in the detection range according to the RCS.

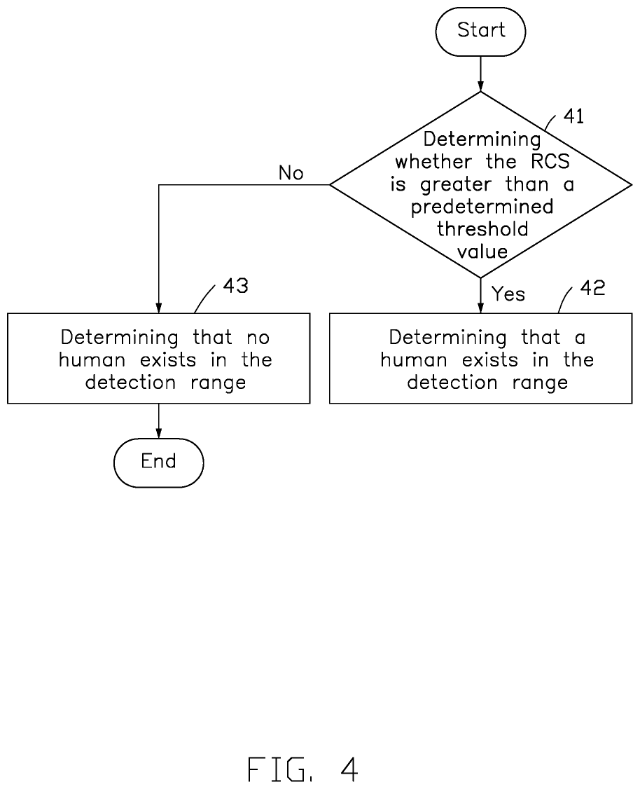

As shown in FIG. 4, the determining whether a human exists in the detection range according to the RCS includes:

At block 41, determining whether the RCS is greater than a predetermined threshold value.

At block 42, if determining the RCS is greater than the predetermined threshold value, determining that a human exists in the detection range.

At block 43, if it is determined that the RCS is less than or equal to the predetermined threshold value, then determining that no human exists in the detection range, and the flow ends.

In at least one embodiment, the method further includes: obtaining a millimeter-wave radar backscattered signal of a former time period in the detection range. The determining whether a human exists in the detection range according to the RCS includes: determining a ratio of areas with phase difference to areas without phase difference according to the millimeter-wave radar backscattered signal and the millimeter-wave radar backscattered signal of the former time period. If the ratio is greater than a predetermined ratio, determining that a human exists in the detection range. In at least one embodiment, the term “human” includes actual humans, human bodies or humanoid objects of certain in shapes and sizes.

At block 23, determining a human centroid according to the point cloud information of the millimeter-wave radar backscattered signal.

In at least one embodiment, the human centroid indicates a point that a quality of an object system focuses on. The human centroid can be used to represent a human or a human body. The human centroid cannot be outside a humanoid shape.

In at least one embodiment, the determining a human centroid according to the point cloud information of the millimeter-wave radar backscattered signal includes: tracking human dynamic information according to the point cloud information of the millimeter-wave radar backscattered signal using target tracking model and Kalman filter algorithm, determining positional information of human points according to the tracked human dynamic information, and determining the human centroid according to the positional information. In at least one embodiment, the target tracking model is Gtrack algorithm. In at least one embodiment, noise is filtered out by the Kalman filter algorithm.

At block 24, removing noise of the point cloud information according to the human centroid.

In at least one embodiment, the removing noise of the point cloud information according to the human centroid includes: removing noise of the point cloud information according to the human centroid by ghost image cancellation.

In at least one embodiment, the removing noise of the point cloud information according to the human centroid by ghost image cancellation includes: removing noise of the point cloud information according to the human centroid and a signal strength of the point cloud information. The removing noise of the point cloud information according to the human centroid and a signal strength of the point cloud information includes: removing data in the point cloud information of which the signal noise ratio (SNR) is less than a predetermined strength. The predetermined strength can be 0, 0.05, etc.

In at least one embodiment, the removing noise of the point cloud information according to the human centroid by ghost image cancellation includes: removing a part of the point cloud information with a distance to the human centroid that is greater than a predetermined distance. Therefore, filtering points away from the human centroid and improving precise identification of human postures. In at least one embodiment, the points close to the human centroid can be regarded as valid points; and the points away from the human centroid can be filtered. The removing a part of the millimeter-wave radar backscattered signal that a distance to the human centroid is greater than a predetermined distance includes: removing a part of the millimeter-wave radar backscattered signal that a distance to the human centroid in a first determined direction is greater than a first predetermined distance, removing a part of the millimeter-wave radar backscattered signal that a distance to the human centroid in a second determined direction is greater than a second predetermined distance, and removing a part of the millimeter-wave radar backscattered signal that a distance to the human centroid in a third determined direction is greater than a third predetermined distance. The first predetermined distance, the second determined distance, and the third predetermined distance can be respectively the X axis, the Y axis, and the Z axis or straight lines that form predetermined angles to the X axis, the Y axis, and the Z axis.

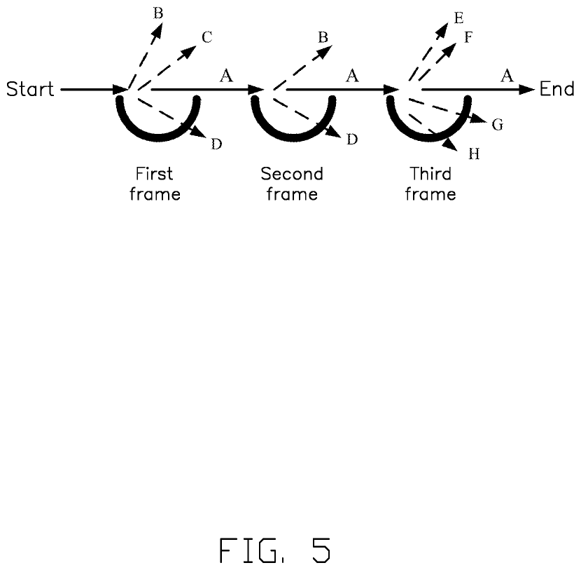

FIG. 5 illustrates a schematic view of the method for identifying human postures according to removing noise of the point cloud information according to the human centroid by ghost image cancellation. A first frame of millimeter-wave radar backscattered signal, a second frame of millimeter-wave radar backscattered signal, and a third frame of millimeter-wave radar backscattered signal exists in a human A. The first frame of millimeter-wave radar backscattered signal includes point cloud information of A, point cloud information of B, point cloud information of C, and point cloud information of D. A signal strength of each of the point cloud information of B, the point cloud information of C, and the point cloud information of D is in each case less than a signal strength of the point cloud information of A or a distance to a centroid of A is greater than the predetermined distance, then removing the point cloud information of B, the point cloud information of C, and the point cloud information of D from the first frame of millimeter-wave radar backscattered signal. The second frame of millimeter-wave radar backscattered signal includes point cloud information of A, point cloud information of B, and point cloud information of D. A signal strength of each of the point cloud information of B and the point cloud information of D is less than a signal strength of the point cloud information of A or a distance to a centroid of A is greater than the predetermined distance, then the point cloud information of B and the point cloud information of D is removed from the second frame of millimeter-wave radar backscattered signal. The third frame of millimeter-wave radar backscattered signal includes point cloud information of A, point cloud information of E, point cloud information of F, point cloud information of G, and point cloud information of H. A signal strength of each of point cloud information of E, point cloud information of F, point cloud information of G, and point cloud information of H is less than a signal strength of the point cloud information of A or a distance to a centroid of A is greater than the predetermined distance, then point cloud information of E, point cloud information of F, point cloud information of G, and point cloud information of H are removed from the third frame of millimeter-wave radar backscattered signal.

In at least one embodiment, the removing noise of the millimeter-wave radar backscattered signal according to the human centroid further includes: removing noise of the millimeter-wave radar backscattered signal according to the human centroid by data smoothing.

In at least one embodiment, the obtaining millimeter-wave radar backscattered signal in a millimeter-wave radar detection range includes: obtaining a frame of millimeter-wave radar backscattered signal in the millimeter-wave radar detection range at predetermined intervals. The removing noise of the millimeter-wave radar backscattered signal according to the human centroid by data smoothing includes: determining whether a positional change between a position of the human centroid in a present frame of millimeter-wave radar backscattered signal and a position the human centroid in a former frame of millimeter-wave radar backscattered signal is greater than a predetermined value. The positional change includes at least one of a height change and a displacement change. If the positional change between the position of the human centroid in a present frame of millimeter-wave radar backscattered signal and the position of the human centroid in a former frame of millimeter-wave radar backscattered signal is greater than the predetermined value, such the present frame of millimeter-wave radar backscattered signal is removed. If the positional change between the position of the human centroid in a present frame of millimeter-wave radar backscattered signal and the position of the human centroid in the former frame of millimeter-wave radar backscattered signal is less than or equal to the predetermined value, reserving the present frame of millimeter-wave radar backscattered signal. In at least one embodiment, if the present frame of millimeter-wave radar backscattered signal is the first frame, the former frame of millimeter-wave radar backscattered signal is the present frame of millimeter-wave radar backscattered signal.

The removing noise of the millimeter-wave radar backscattered signal according to the human centroid by data smoothing further includes: equalizing position information of the human centroid in the frame of millimeter-wave radar backscattered signal that is stored within a predetermined period. The equalizing position information of the human centroid in the frame of millimeter-wave radar backscattered signal that is stored within a predetermined period includes: equalizing at least one of the height and displacement of the human centroid in the frame of millimeter-wave radar backscattered signal that is stored within the predetermined period.

At block 25, identifying the human posture according to the point cloud information after noise removal.

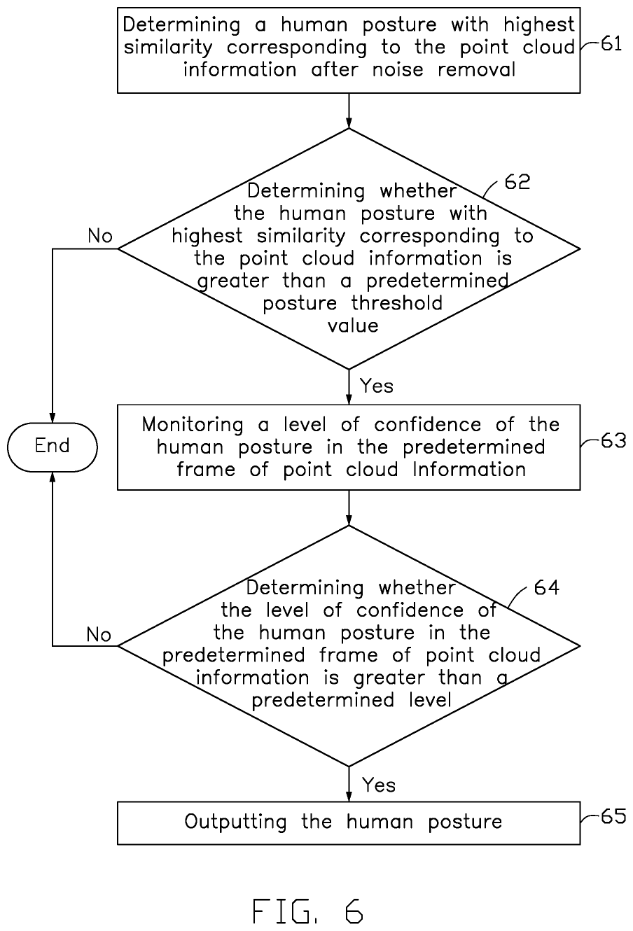

As shown in FIG. 6, the identifying the human posture according to the point cloud information after noise removal includes:

At block 61, determining a human posture with highest similarity corresponding to the point cloud information after noise removal.

In at least one embodiment, the determining a human posture with highest similarity corresponding to the point cloud information after noise removal includes: determining a human posture with highest similarity corresponding to the point cloud information after noise removal according the human centroid.

The determining a human posture with highest similarity corresponding to the point cloud information after noise removal includes: obtaining human characteristic information according to the point cloud information after noise removal by contour drawing; and determining a human posture with highest similarity corresponding to the point cloud information after noise removal according to the human characteristic information.

The obtaining human characteristic information according to the point cloud information after noise removal by contour drawing includes: obtaining human characteristic information according to the point cloud information after noise removal and a predetermined relationship by contour drawing. The predetermined relationship includes a relationship of predetermined data of the point cloud information and the human characteristic information. The predetermined relationship is shown in Table 1 as below:

TABLE 1

| predetermined data of the | human characteristic |
|---|---|
| point cloud information | information |
| Height changes | Whether human posture changes |
| Human triaxial displacement | Moving or still |
| Distance distribution proportion of | Closeness of the triaxial data and |
| human triaxial data to the human | the human centroid |
| centroid | |
| distribution proportion of human Y | Whether human is close to the |
| axis data close to the ground | ground |
| Size of the human in three axial | Height, length, and width of |
| dimensions | human |

In at least one embodiment, the three axis includes an X axis, a Y axis, and a Z axis. The human postures include at least one of crouching, standing, moving forward, moving back, sitting, bowing, and/or falling down.

In another embodiment, determining a human posture with highest similarity corresponding to the point cloud information after noise removal without the human centroid. In this situation, the distance distribution proportion of human triaxial data to the human centroid and the closeness of the triaxial data and the human centroid can be omitted.

At block 62, determining whether the human posture with highest similarity corresponding to the point cloud information is greater than a predetermined posture threshold value.

At block 63, if the human posture with highest similarity corresponding to the point cloud information is greater than the predetermined posture threshold value, monitoring a level of confidence of the human posture in the predetermined frame of point cloud information.

The predetermined frame of point cloud information dynamically receives multiple frames of point cloud information for the millimeter-wave radar, and operates a smoothing calculation to the predetermined frame of point cloud information after removing noise of the point cloud information. For instance, the millimeter-wave radar dynamically and continuously receives first to thirteenth frames of point cloud information, removes three noise-affected frames of point cloud information and keeps ten frames of point cloud information, operates a smoothing calculation to the ten frames of point cloud information and sets as the predetermined frame of point cloud information. Then the millimeter-wave radar dynamically and continuously receives multiple frames of point cloud information, and dynamically adjust and updates the predetermined frame of point cloud information.

The monitoring a level of confidence of the human posture in the predetermined frame of point cloud information includes: determining a human posture to be determined according to the predetermined frame of point cloud information, comparing the human posture to the human posture to be determined to determine the level of confidence of the human posture in the predetermined frame of point cloud information.

In at least one embodiment, the method further includes: ending the flow of the method if the human posture with highest similarity corresponding to the point cloud information is less than or equal to the predetermined posture threshold value.

At block 64, determining whether the level of confidence of the human posture in the predetermined frame of point cloud information is greater than a predetermined level.

At block 65, if the level of confidence of the human posture in the predetermined frame of point cloud information is greater than a predetermined level, outputting the human posture.

In at least one embodiment, the higher the similarity of the human posture and the human posture to be determined, then the higher is the level of confidence of the human posture in the predetermined frame of point cloud information. The lower the similarity of the human posture and the human posture to be determined, then the lower is the level of confidence of the human posture in the predetermined frame of point cloud information.

In at least one embodiment, the method further includes: ending the flow of the method if the level of confidence of the human posture in the predetermined frame of point cloud information is less than or equal to the predetermined level.

The method for identifying human postures using the millimeter-wave radar, also protects individual privacy. Determination of a human existing in the detection range according to the millimeter-wave radar backscattered signal avoids unnecessary calculation and determinations when no human exists in the detection range. Determination of the human centroid facilitates noise removal from the point cloud information. The noises removal of the point cloud information aids in effective extraction of characteristics to improve precision identification of human postures. Noises removal of the point cloud information by ghost image cancellation enhances signal strengths, and data smoothing of the point cloud information remove noise.

FIG. 7 illustrates a schematic view of an embodiment of an apparatus 7 for identifying human postures. The apparatus 7 includes a millimeter-wave radar 71, an analog-to-digital converter (not shown), at least one processor 73, a memory 74, and a system 10 for identifying human postures stored in the memory 74 and run by the at least one processor 73.

The millimeter-wave radar 71 is configured to transmit linear frequency modulation continuous wave signals in the detection range and receive the millimeter-wave radar backscattered signal in the detection range.

The millimeter-wave radar 71 is configured to sample the millimeter-wave radar backscattered signal in the millimeter-wave radar detection range through the analog-digital converter.

The at least one processor 73 is configured to perform the method for identifying human postures. The at least one processor 73 is configured to perform functions of the elements of the system 10 for identifying human postures.

The system 10, as shown in FIG. 1, for identifying human postures can be divided into one or more elements/modules, such as the elements shown in FIG. 1, the one or more elements/modules are stored in the memory 74 and can be run by the at least one processor 73 to perform the method for identifying human postures. The one or more elements/modules can be computer program instructions describing a perform process of the system 10 for identifying human postures in the apparatus 7 for identifying human postures.

In at least one embodiment, the apparatus 7 for identifying human postures can be any electronic devices, such as personal computers, tablet computers, smart phones, personal digital assistants (PDAs), etc. A structure of the apparatus 7 for identifying human postures is not limited to that shown in FIG. 7, the apparatus 7 for identifying human postures can be in bus configuration or in star configuration. The apparatus 7 for identifying human postures can include more hardwares, softwares, and other necessary elements.

In at least one embodiment, the at least one processor 73 can be formed by integrated circuits, such as an individual integrated circuit or multiple integrated circuits with a same function or different functions. The at least one processor 73 includes but is not limited to a central processing unit (CPU), a microprocessor, a digital signal processor (DSP), a graphics processor, an application specific integrated circuit (ASIC), a field-programmable gate array (FPGA), a data processor chip, a programmable logic device (PLD), a discrete gate/transistor logic device, or a discrete hardware component. The processor 73 may be a control unit and electrically connected to other elements of the apparatus 7 through interfaces or a bus. In at least one embodiment, the various types of non-transitory computer-readable storage mediums stored in the memory 74 can be processed by the at least one processor 73 to perform various of functions, such as the method for identifying human postures.

In at least one embodiment, the memory 74 can include various types of non-transitory computer-readable storage mediums. For example, the memory 74 can store local paths and the system 10 for identifying human postures. The memory 74 can rapidly and automatically access instructions and data when the apparatus 7 is running. The memory 74 can be an internal storage system, such as a flash memory, a Random Access Memory (RAM) for the temporary storage of information, and/or a Read-Only Memory (ROM), a Programmable Read-Only Memory (PROM), Erasable Programmable Read-Only Memory (EPROM), a One-time Programmable Read-Only Memory (OTPROM), Electrically-Erasable Programmable Read-Only Memory (EEPROM), Compact Disc Read-Only Memory (CD-ROM) for permanent storage of information. The memory 74 can also be an external storage system, such as a hard disk, a storage card, or a data storage medium.

A non-transitory computer-readable storage medium including program instructions for causing the apparatus to perform the method for identifying human postures is also disclosed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being embodiments of the present disclosure.

What is claimed is:

1. A method for identifying human postures comprising:
obtaining a millimeter-wave radar backscattered signal in a millimeter-wave radar detection range; wherein the millimeter-wave radar backscattered signal comprises point cloud information;
determining whether a human exists in the detection range according to the millimeter-wave radar backscattered signal;
determining a human centroid according to the point cloud information of the millimeter-wave radar backscattered signal;
removing noise of the point cloud information according to the human centroid; and
identifying a human posture according to the point cloud information after noise removal.

2. The method according to claim 1, wherein the determining whether the human exists in the detection range according to the millimeter-wave radar backscattered signal comprises:
determining a high range resolution profile (HRRP) of the millimeter-wave radar according to the millimeter-wave radar backscattered signal;
determining a radar cross section (RCS) of objects in the detection range according to the HRRP of the millimeter-wave radar; and
determining whether the human exists in the detection range according to the RCS.

3. The method according to claim 1, further comprising:
obtaining a millimeter-wave radar backscattered signal of a former time period in the detection range;
wherein the determining whether the human exists in the detection range according to the RCS comprises:
determining a ratio of areas with phase difference to areas without phase difference according to the millimeter-wave radar backscattered signal and the millimeter-wave radar backscattered signal of the former time period;
determining that the human exists in the detection range if the ratio is greater than a predetermined ratio.

4. The method according to claim 1, wherein the removing noise of the point cloud information according to the human centroid comprises:
removing noise of the point cloud information according to the human centroid by ghost image cancellation.

5. The method according to claim 4, wherein the removing noise of the point cloud information according to the human centroid by ghost image cancellation comprises:
removing noise of the point cloud information according to the human centroid and a signal strength of the point cloud information; and/or
removing a part of the point cloud information with a distance to the human centroid that is greater than a predetermined distance.

6. The method according to claim 4, wherein the removing noise of the point cloud information according to the human centroid by ghost image cancellation comprises:
removing noise of the point cloud information with insufficient valid points in the detection range.

7. The method according to claim 1, wherein the removing noise of the point cloud information according to the human centroid comprises:
removing noise of the point cloud information according to the human centroid by data smoothing.

8. The method according to claim 7, wherein
the obtaining millimeter-wave radar backscattered signal in a millimeter-wave radar detection range comprises:
obtaining a frame of millimeter-wave radar backscattered signal in the millimeter-wave radar detection range at predetermined intervals;
the removing noise of the point cloud information according to the human centroid by data smoothing comprises:
determining whether a positional change between a position of the human centroid in a present frame of millimeter-wave radar backscattered signal and a position the human centroid in a former frame of millimeter-wave radar backscattered signal is greater than a predetermined value; wherein the positional change comprises at least one of a height change and a displacement change;
removing the present frame of millimeter-wave radar backscattered signal if the positional change between the position of the human centroid in a present frame of millimeter-wave radar backscattered signal and the position of the human centroid in a former frame of millimeter-wave radar backscattered signal is greater than the predetermined value;
reserving the present frame of millimeter-wave radar backscattered signal if the positional change between the position of the human centroid in a present frame of millimeter-wave radar backscattered signal and the position of the human centroid in the former frame of millimeter-wave radar backscattered signal is less than or equal to the predetermined value; and
equalizing position information of the human centroid in the frame of millimeter-wave radar backscattered signal that is stored within a predetermined period.

9. The method according to claim 1, wherein the identifying the human posture according to the point cloud information after noise removal comprises:
identifying the human posture according to distribution proportions of the point cloud information and the positions of the human centroid.

10. The method according to claim 1, wherein the human centroid indicates a point that a quality of an object system focuses on, the human centroid represents a human or a human body; the human posture includes at least one of crouching, standing, moving forward, moving back, sitting, bowing, and/or falling down.

11. A apparatus for identifying human postures comprising:
at least one processor; and
at least one memory coupled to the at least one processor and storing program instructions; the memory and the program instructions configured to, with the at least one processor, cause the apparatus to perform:
obtaining a millimeter-wave radar backscattered signal in a millimeter-wave radar detection range; wherein the millimeter-wave radar backscattered signal comprises point cloud information;
determining whether a human exists in the detection range according to the millimeter-wave radar backscattered signal;
determining a human centroid according to the point cloud information of the millimeter-wave radar backscattered signal;
removing noise of the point cloud information according to the human centroid; and
identifying a human posture according to the point cloud information after noise removal.

12. The apparatus according to claim 11, wherein the determining whether the human exists in the detection range according to the millimeter-wave radar backscattered signal comprises:
determining a high range resolution profile (HRRP) of the millimeter-wave radar according to the millimeter-wave radar backscattered signal;
determining a radar cross section (RCS) of objects in the detection range according to the HRRP of the millimeter-wave radar; and
determining whether the human exists in the detection range according to the RCS.

13. The apparatus according to claim 11, further comprising:
obtaining a millimeter-wave radar backscattered signal of a former time period in the detection range;
wherein the determining whether the human exists in the detection range according to the RCS comprises:
determining a ratio of areas with phase difference to areas without phase difference according to the millimeter-wave radar backscattered signal and the millimeter-wave radar backscattered signal of the former time period;
determining that the human exists in the detection range if the ratio is greater than a predetermined ratio.

14. The apparatus according to claim 11, wherein the removing noise of the point cloud information according to the human centroid comprises:
removing noise of the point cloud information according to the human centroid by ghost image cancellation.

15. The apparatus according to claim 14, wherein the removing noise of the point cloud information according to the human centroid by ghost image cancellation comprises:
removing noise of the point cloud information according to the human centroid and a signal strength of the point cloud information; and/or
removing a part of the point cloud information with a distance to the human centroid that is greater than a predetermined distance.

16. The apparatus according to claim 14, wherein the removing noise of the point cloud information according to the human centroid by ghost image cancellation comprises:
removing noise of the point cloud information with insufficient valid points in the detection range.

17. The apparatus according to claim 11, wherein the removing noise of the point cloud information according to the human centroid comprises:
removing noise of the point cloud information according to the human centroid by data smoothing.

18. The apparatus according to claim 17, wherein
the obtaining millimeter-wave radar backscattered signal in a millimeter-wave radar detection range comprises:
obtaining a frame of millimeter-wave radar backscattered signal in the millimeter-wave radar detection range at predetermined intervals;
the removing noise of the point cloud information according to the human centroid by data smoothing comprises:
determining whether a positional change between a position of the human centroid in a present frame of millimeter-wave radar backscattered signal and a position the human centroid in a former frame of millimeter-wave radar backscattered signal is greater than a predetermined value; wherein the positional change comprises at least one of a height change and a displacement change;
removing the present frame of millimeter-wave radar backscattered signal if the positional change between the position of the human centroid in a present frame of millimeter-wave radar backscattered signal and the position of the human centroid in a former frame of millimeter-wave radar backscattered signal is greater than the predetermined value;
reserving the present frame of millimeter-wave radar backscattered signal if the positional change between the position of the human centroid in a present frame of millimeter-wave radar backscattered signal and the position of the human centroid in the former frame of millimeter-wave radar backscattered signal is less than or equal to the predetermined value; and
equalizing position information of the human centroid in the frame of millimeter-wave radar backscattered signal that is stored within a predetermined period.

19. The apparatus according to claim 11, wherein the identifying the human posture according to the point cloud information after noise removal comprises:
identifying the human posture according to distribution proportions of the point cloud information and the positions of the human centroid.

20. A non-transitory computer readable medium comprising program instructions for causing an apparatus to perform at least the follow:
obtaining a millimeter-wave radar backscattered signal in a millimeter-wave radar detection range; wherein the millimeter-wave radar backscattered signal comprises point cloud information;
determining whether a human exists in the detection range according to the millimeter-wave radar backscattered signal;
determining a human centroid according to the point cloud information of the millimeter-wave radar backscattered signal;
removing noise of the point cloud information according to the human centroid; and
identifying a human posture according to the point cloud information after noise removal.
